(19) United States
(12) Patent Application Publication
(10) Pub. No.: US 2013/0113303 A1
(43) Pub. Date: May 9, 2013

(54) SAFETY SYSTEM FOR MACHINERY

(71) Applicant: HOLLYMATIC CORPORATION, Countryside, IL (US)

(72) Inventors: Hardev S. SOMAL, La Grange Highlands, IL (US); Erik BAUER, Alto, MI (US)

(73) Assignee: HOLLYMATIC CORPORATION, Countryside, IL (US)

(21) Appl. No.: 13/669,053

(22) Filed: Nov. 5, 2012

Related U.S. Application Data
(60) Provisional application No. 61/555,315, filed on Nov. 3, 2011.

(51) Int. Cl. H02H 11/00

(52) U.S. Cl. 307/326

(57) ABSTRACT

Embodiments may disclose a safety system for controlling an operation of a machine operated by an operator wearing an article of luminescent clothing, the system including a luminescent sensor configured to emit ultraviolet light toward a target area, and configured to detect light emitted by the article of luminescent clothing; a motor configured to drive a component of the machine; and a controller configured to control the motor and the luminescent sensor, wherein if the luminescent sensor detects the light emitted by the article of luminescent clothing within the target area, the controller controls the motor to stop driving the component of the machine.

### CROSS-REFERENCE TO RELATED APPLICATION

This application claims priority under 35 USC §119 to U.S. Provisional Application No. 61/555,315, filed on Nov. 3, 2011, the contents of which are herein incorporated by reference in its entirety.

### BACKGROUND

1. Technical Field

Embodiments relate to a safety system, referred to as an “invisible guard,” for machinery. More particularly, embodiments relate to the invisible guard for machinery, which protects an operator from harm.

2. Description of the Related Art

In the related art, interlocked doors, covers, and lids inhibit access to hazardous areas of a machine. For example, if a user is trying to cut a piece of wood, a cover on a blade may inhibit access to the user when the user operates the blade. However, these safety devices may have a limited range of operation. Further, even if there is no limited range of operation, the related art safety devices may limit access to the working zone. In addition, related art safety devices may only work as “after-the-fact” devices (e.g., emergency STOP switches).

For “after-the-fact” devices of the related art, fast moving machines are capable of doing a lot of damage by the time an operator reacts to an emergency situation. Further, it may not even be possible for the operator to reach the emergency STOP switch. For example, if the operator is injured by a fast-moving machine, the operator may not be physically capable of reaching and/or operating the emergency STOP switch.

In view of the above, an improved safety system is desired that will keep the operator safe before the onset of an accident, while allowing maximum access to the working zone of the machine.

### SUMMARY

Example embodiments provide a safety system, referred to as an “invisible guard,” for machinery, which protects an operator from harm.

According to example embodiments, a safety system for controlling an operation of a machine operated by an operator wearing an article of luminescent clothing includes: a luminescent sensor configured to emit ultraviolet light toward a target area, and configured to detect light emitted by the article of luminescent clothing; a motor configured to drive a component of the machine; and a controller configured to control the motor and the luminescent sensor, wherein if the luminescent sensor detects the light emitted by the article of luminescent clothing within the target area, the controller controls the motor to stop driving the component of the machine.

The safety system may further include: a beam shaper to shape the ultraviolet light emitted toward the target area.

The beam shaper may shape the ultraviolet light into a u-shaped configuration.

The beam shaper may shape the ultraviolet light into a rectangular shape.

The beam shaper may shape the ultraviolet light into the rectangular shape such that longer sides of the rectangle extend in a y axis direction.

The longer sides of the rectangle may be substantially 5 inches and shorter sides of the rectangle may be substantially 0.5 inches.

The beam shaper may shape the ultraviolet light into the rectangular shape such that longer sides of the rectangle extend in an x axis direction.

The shape of the ultraviolet light may be emitted towards the target area in a circle.

The circle may have a diameter of substantially five inches.

The article of luminescent clothing may be a glove with an anti-microbial additive.

The glove may be approved by the Food and Drug Administration (FDA) for direct contact with food.

The safety system may further include: an electrical brake connected to the motor, the electrical brake accepts an instruction from the controller, wherein the controller controls the electric brake connected to the motor to stop driving the component of the machine when the luminescent sensor detects the light emitted by the article of luminescent clothing within the target area.

The controller may stop driving the component of the machine in less than 0.7 seconds with the electrical brake.

The safety system may further include: a dual brake connected to the motor, the dual brake comprises an electric brake and a mechanical brake and accepts an instruction from the controller, wherein the controller controls the dual brake connected to the motor to stop driving the component of the machine when the luminescent sensor detects the light emitted by the article of luminescent clothing within the target area.

The controller may stop driving the component of the machine in less than 0.5 seconds.

The component of the machine may be a cutting blade.

A vertical distance from the luminescent sensor to the target area may be substantially up to 15.75 inches.

According to example embodiments, a safety system for controlling an operation of a machine operated by an operator wearing an article of luminescent clothing further includes: a luminescent sensor configured to emit ultraviolet light toward a target area, and configured to detect light emitted by the article of luminescent clothing; a motor configured to drive a component of the machine; a dual brake connected to the motor, the dual brake comprises an electric brake and a mechanical brake and accepts an instruction from the controller; and a controller configured to control the motor and the luminescent sensor, wherein if the luminescent sensor detects the light emitted by the article of luminescent clothing within the target area, the controller controls the dual brake connected to the motor to stop driving the component of the machine.

According to example embodiments, a method of a safety system for controlling an operation of a machine operated by an operator wearing an article of luminescent clothing may include: driving a component of the machine with a motor; detecting when the article of luminescent clothing enters a target area near the component of the machine; and controlling the motor to stop driving the component of the machine when the detection occurs.

### BRIEF DESCRIPTION OF THE DRAWINGS

Illustrative, non-limiting example embodiments will be more clearly understood from the following detailed description taken in conjunction with the accompanying drawings.

FIG. 1 is a diagram illustrating an exemplary embodiment of a safety control system with a luminescent sensor and a beam shaper.

FIG. 2 is a diagram illustrating an exemplary embodiment of a safety control system with a luminescent sensor and no beam shaper.

FIG. 3 is a diagram illustrating a dual braking system.

FIG. 4 is a diagram illustrating a detailed configuration of a mechanical brake of FIG. 3.

FIG. 5 is a diagram illustrating an exemplary embodiment of a beam shaper forming a rectangular shape with longer sides of the rectangle extending in an x direction.

FIG. 6 is a diagram illustrating an exemplary embodiment of a beam shaper forming a rectangular shape with longer sides of the rectangle extending in a y direction.

FIG. 7 is a diagram illustrating an exemplary embodiment of a beam shaper forming a u-shaped configuration.

### DETAILED DESCRIPTION OF THE EMBODIMENTS

Various example embodiments will be described more fully hereinafter with reference to the accompanying drawings, in which some example embodiments are shown. Example embodiments may, however, be embodied in many different forms and should not be construed as limited to the example embodiments set forth herein. Rather, these example embodiments are provided so that this disclosure will be thorough and complete, and will fully convey the scope of the embodiments to those skilled in the art. In the drawings, the sizes and relative sizes of layers and regions may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of the embodiments. As used herein, the term “and/or” includes any and all combinations of one or more of the associated listed items.

It will be understood that when an element is referred to as being “connected”, “attached”, or “coupled” to another element, it can be directly connected, attached, coupled to the other element or intervening elements may be present. In contrast, when an element is referred to as being “directly connected”, “directly attached”, or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments only and is not intended to be limiting of the embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which these embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

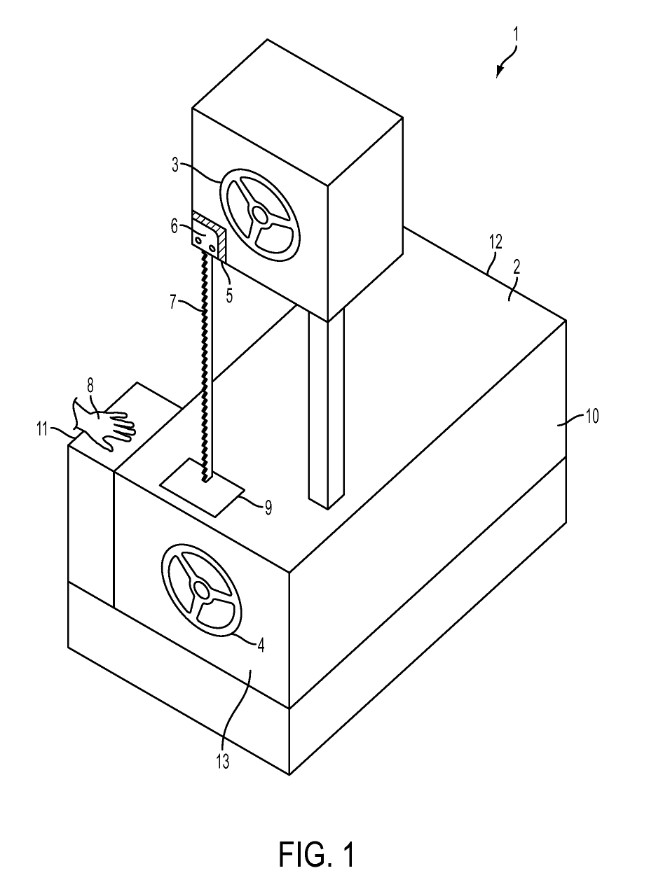

FIG. 1 is a diagram illustrating an exemplary embodiment of a safety control system with a luminescent sensor and a beam shaper.

A safety system 1 of FIG. 1 includes a machine 2. The machine 2 includes a first flywheel 3, a second flywheel 4, a luminescent sensor 5, a beam shaper 6, a component 7, an article of luminescent clothing 8, a target area 9, a right side 10, a left side 11, a back side 12, and a front side 13.

In the safety system 1 of FIG. 1, the article of luminescent clothing 8 (i.e., a glove) may be interwoven with luminescent material. The article of luminescent clothing 8 may also have anti-microbial additives. The article of luminescent clothing 8 may also be approved by the Food and Drug Administration (FDA) and/or the United States Department of Agriculture (USDA) for direct contact with food. A related art knitting glove may have luminescence properties. However, the related art knitting glove is not approved by the FDA and/or USDA because knitted gloves are difficult to keep hygienic. Embodiments of the article of luminescent clothing 8 approved by the FDA and/or the USDA may not be required for non food related machinery.

Further, related art rubber gloves do not have luminescence material. Therefore, embodiments have a specific configuration in which the luminescent material is interwoven into the rubber glove.

However, embodiments are not limited. The article of luminescent clothing 8 may also be a boot, or any other clothing that is worn by an operation of the machine 2. The article of luminescent clothing 8 may also be elastic, with the elastic material formed with the luminescent material. The article of luminescent clothing 8 may also have an additive, such as fluorescent dye/pigments, to the glove material during the molding/casting process. The article of luminescent clothing 8 may also have a coating applied to a surface of the glove, instead of interwoven luminescent material. Further, article of luminescent clothing 8 can be made from any material as long as the material is luminescent. In another embodiment, a transparent glove may used with no luminescent properties. The transparent glove may have a same functionality and detection methods, as long as the transparent glove is paired with a temperature sensor (further described below).

Further, a component 7 (i.e., a cutting blade) may be used to cut different items. As an example, the component 7 may be used to cut meat. However, embodiments are not limited. The component 7 may be any instrument that is used for cutting (i.e., saw). For example, the component 7 may be any pinch or pressure point due to moving machine parts, such as patty machines, meat slicers, meat grinders, tenderizers, punch presses, or any other machinery. The component 7 may be driven up to a speed of 7200 feet/minute.

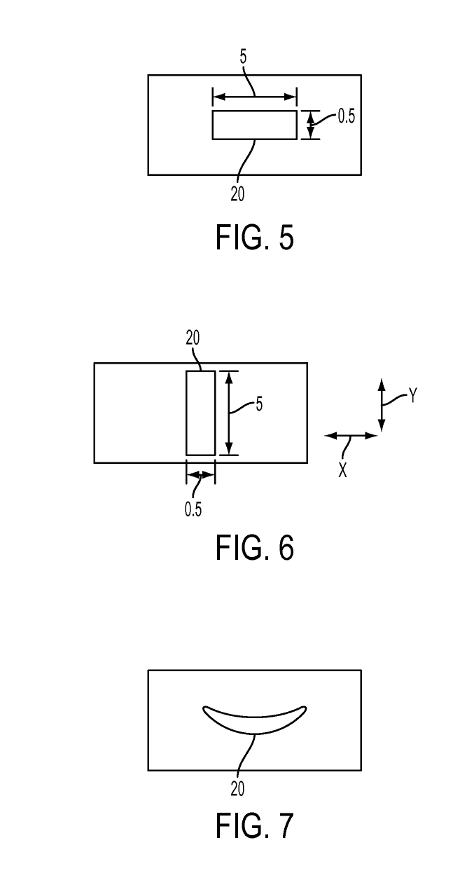

The machine 2 of FIG. 1 may also include a luminescent sensor 5 and a beam shaper 6. The luminescent sensor 5 may be an ultraviolet (UV) sensor which emits invisible, modulated UV light. The luminescent sensor 5 may be mounted right above the component 7. In the embodiment of FIG. 1, a beam shaper 6 may cover the luminescent sensor 5. The beam shaper 6 may shape the beam coming out of the luminescent sensor into different shapes (described in FIGS. 5-7 below). The luminescent sensor 5 may be mounted in different configurations based on the target area 9 and the vertical distance between the luminescent sensor 5 and the target area 9. In a preferred embodiment, the vertical distance between the luminescent sensor 5 and the target area 9 may be 15.75 inches. In an alternative embodiment, the luminescent sensor 5 may emit UV light towards a mirror. In the alternative embodiment, the mirror may reflect the emitted UV light towards the target area 9.

The luminescent sensor 5 may emit UV light toward a target area 9. The target area 9 may be determined by the beam shaper 6. Further, the luminescent sensor 5 may have both an emitter and a receiver for sending and detecting the article of luminescent clothing 8 entering the target area 9. When the UV light strikes the article of luminescent clothing 8, the article of luminescent clothing 8 may glow due to photons of light emitted from the article of luminescent clothing 8.

An operation of the safety system 1 of FIG. 1 will now be described. An operator puts on the article of luminescent clothing 8 (for example, a glove). Then, the machine 2 is turned on, and the component 7 starts to be driven for cutting. As soon as power is applied to the machine 2, the luminescent sensor 5 starts emitting light.

The operator then puts a piece of meat on the machine 2, and moves the meat toward the component 7. If the article of luminescent clothing 8 does not enter the target area 9, no further operation is performed. However, if the article of luminescent clothing 8 enters the target area, the luminescent sensor 5 detects (through its receiver) light emitted by the article of luminescent clothing 8. In other words, the luminescent clothing 8 reflects the light emitted by the luminescent sensor 5, so that the light is received by the luminescent sensor 5.

If the luminescent sensor 5 detects that the article of luminescent clothing 8 enters the target area 9, the controller (not shown) controls the motor (not shown) to stop driving the component 7 of the machine 2. Therefore, the component 7 of the machine 2 is stopped, and the operator is not harmed. However, embodiments are not limited. The controller may set the target area 9 of the luminescent sensor 5 to be a different shaper or size than the default setting.

Although a system of the related art may have an emergency stop SWITCH, the operator may not be able to reach the emergency stop SWITCH in time. In embodiments, the component 7 of the machine 2 is stopped in time so that the operator is not harmed.

Moreover, in the system of the related art, even if the operator hits the emergency stop SWITCH in time, the cutting blade may take too long time to stop. In embodiments, by using a dual braking system 19, the component 7 of the machine 2 is stopped in time so that the operator is not harmed.

Further, although a system of the related art may inhibit access to hazardous areas of the machine, the system of the related art may greatly limit access to the working zone of the system. In embodiments, the component 7 of the machine 2 may prevent harm to the operator while still allowing the operator to have access to the working zone of the system.

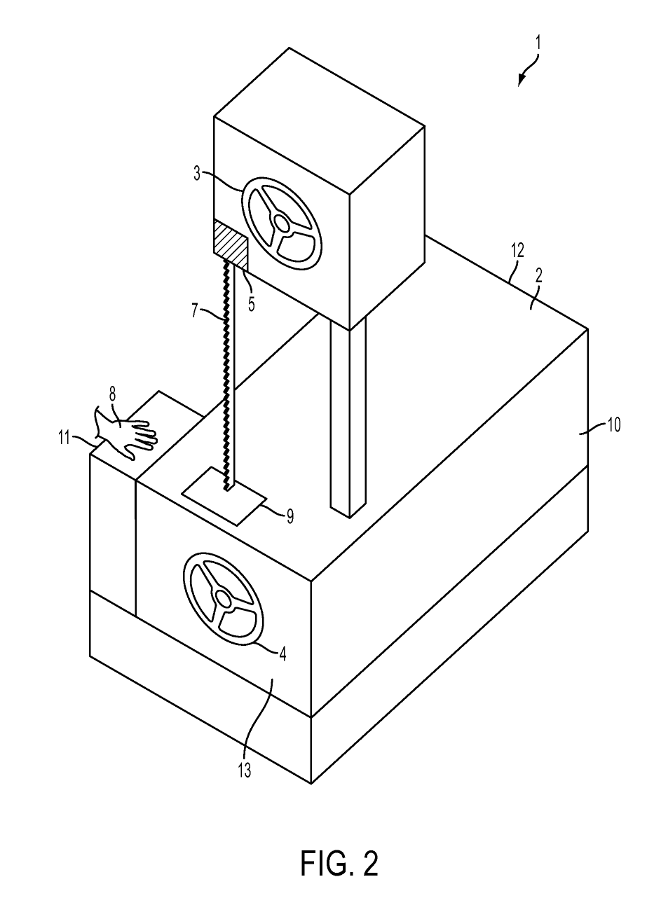

FIG. 2 is a diagram illustrating an exemplary embodiment of a safety control system with a luminescent sensor and no beam shaper.

FIG. 2 is similar to FIG. 1, except for the fact that FIG. 2 has no beam shaper 6. Therefore, detailed description of FIG. 2 is omitted. If the safety control system has no beam shaper 6, the target area 9 becomes a circle. In an embodiment of FIG. 2, the circle has a diameter of five inches. If the luminescent sensor 5 detects that the article of luminescent clothing 8 enters the target area 9 (i.e., the circle), the controller (not shown) controls the motor (not shown) to stop driving the component 7 of the machine 2. Therefore, the component 7 of the machine 2 is stopped, and the operator is not harmed. The controller may be driven by a variable-frequency drive (VFD), which immediately activates the braking function. However, embodiments are not limited. The circle may be set to have a different diameter based on the controller. The circle may also be set to have a different diameter based on the position of the luminescent sensor 5.

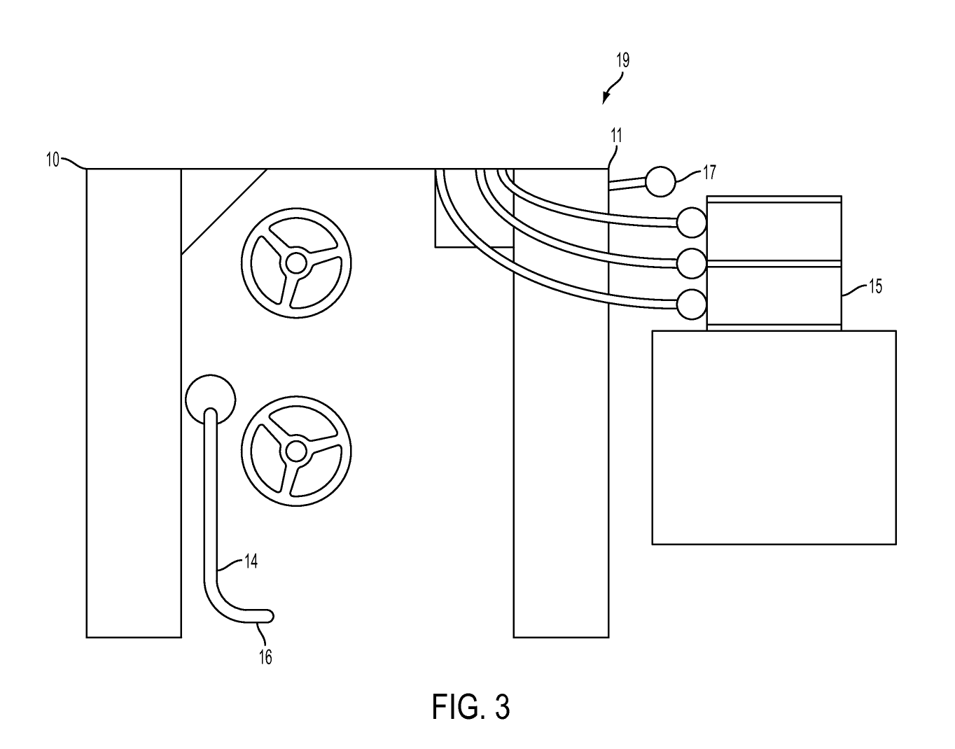

FIG. 3 is a diagram illustrating a dual braking system. For reference, the dual braking system 19 may be disposed in the back side 12 of machine 2 in FIG. 1.

The dual braking system 19 may have a mechanical brake 14 and an electrical brake 15. The electrical brake 15 may work with a start and stop knob 17. If the start and stop knob 17 is pushed, the electrical brake 15 may stop. If the start and stop knob 17 is pulled, the electrical brake 15 may start. However, embodiments are not limited. If the start and stop knob 17 is pushed, the electrical brake 15 may start. Further, if the start and stop knob 17 is pulled, the electrical brake 15 may stop.

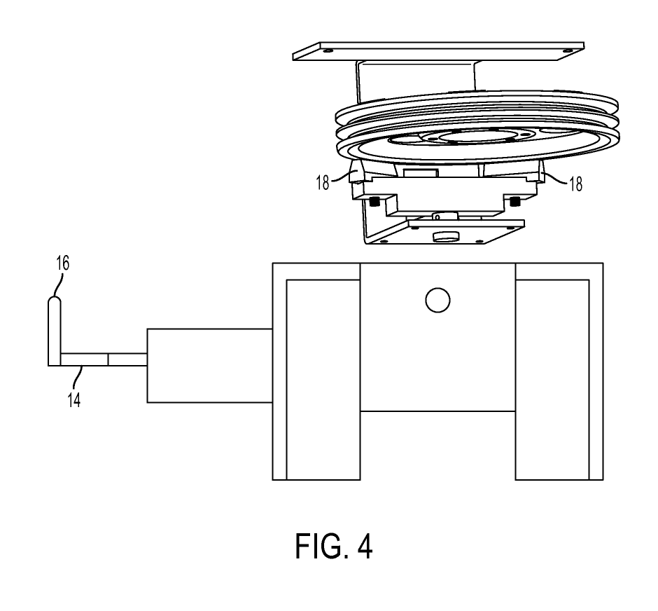

The mechanical brake 14 may work with a valve 16. As shown in FIG. 4, the valve 16 of the mechanical brake 14 may be controlled so that the brake pads 18 move towards each other to stop the component 7. However, embodiments are not limited. The valve 16 of the mechanical brake 14 may be controlled such that the brake pads 18 move away from each other to stop the component 7.

In FIG. 3 of the instant specification, the dual braking system 19 may apply both the mechanical brake 14 and the electrical brake 15 to stop the component 7. In the dual braking system 19, the controller may stop driving the component of the machine in less than or equal to 0.5 seconds. However, embodiments are not limited. An embodiment of the instant specification may apply only the electrical brake 15 to stop the component 7. If only the electrical brake 15 is used to stop the component, the controller may stop driving the component of the machine in less than or equal to 0.7 seconds. Further, another embodiment of the instant specification may only apply the mechanical brake 14 to stop the component 7.

In FIG. 4 of the instant specification, the brake pads 18 of the embodiments can exert pressure on a same face of a pulley. Therefore, the brake pads 18 of the mechanical brake 14 are easier to set and reset. Further, by turning a motor in reverse, the brake pads 18 of the embodiments may be brought back to create enough room to remove a belt without dismantling the brakes. Finally, embodiments of the mechanical brake 14 have fewer parts. Fewer parts of the mechanical brake 14 in the embodiments allow for a simple, direct, and fast response. In an exemplary embodiment, the mechanical brake 14 does not have left hand screws, right hand screws, nuts, bushings, arms, nut retainers, etc. In the embodiments, the dual braking system 19 has no loss of force or motion in lever ratios.

In FIG. 4 of the instant specification, the brake pads 18 are attached to a brake bar, which is driven linearly by a brake motor. The brake bar acts as a nut, and a screw is attached to a motor shaft. Therefore, the brake bar is constrained from rotating. As the motor is turned on by the luminescent sensor 5 sensing danger to an operator, the brake pads 18 are rammed against the pulley. Therefore, the resulting interference and friction causes the pulley to stop within 0.4 seconds. The brake pads 18 are made from hard urethane. Further, prox sensors (not shown) may be used so the machine 2 cannot be turned ON unless the brake pads 18 are disengaged. Prox sensors may also be used to disable the machine 2 if and when the brake pads 18 are worn beyond a certain limit. Therefore, the safety system 1 may be even safer.

FIGS. 5-7 show different configurations of the bottom of the beam shaper. As shown in FIG. 1, the bottom of the beam shaper 6 may limit the UV light emitted by the luminescent sensor 5. In FIGS. 5-7, the beam shaper 6 may limit the UV light emitted by the luminescent sensor 5 by blocking most of the UV emitted light, except for a slit 20. The slit 20 may allow the UV light to be shaped in different configurations when it hits the target area 9. Therefore, the beam shaper 6 may control the configuration of the target area 9.

FIG. 5 is a diagram illustrating an exemplary embodiment of a beam shaper 6 forming a rectangular shape with longer sides of the rectangle extending in an x direction. FIG. 6 is a diagram illustrating an exemplary embodiment of a beam shaper 6 forming a rectangular shape with longer sides of the rectangle extending in a y direction. In FIGS. 5-6 of the instant specification, the longer sides of the rectangle are 5 inches, and the shorter sides of the rectangle are 0.5 inches. In FIGS. 5-7, the rectangle dimensions can be achieved by using at least one sensor. If multiple sensors are used, the multiple sensors work in co-operation with each other.

However, embodiments are not limited. The rectangle can have different dimensions depending on the application. As an example, all sides of the rectangle can have a same exact size (i.e., a square). Further, other shapes and configurations may be used for the slit 20. FIG. 7 is a diagram illustrating an exemplary embodiment of a beam shaper 6 forming a u-shaped configuration.

The safety system 1 in the embodiments can have several applications. For example, the safety system 1 can be used with meat machinery, metal stamping, punching, break presses, forgings, textile machinery, paper mills, etc. However, embodiments are not limited. The safety system 1 used in the embodiments may be used with any machinery that involves human interaction at the in-feed or at the discharge.

An exemplary embodiment of the safety system 1 may also use a temperature sensor (not shown). In the exemplary embodiment, the temperature sensor may be monitoring for temperatures higher than the ambient temperature and the meat (or wood, metal, etc.). In the exemplary embodiment, an operator's hand can be detected in the target area 9 due to radiated heat from the operator's hand. The temperature sensor continuously monitors the temperature in front of the component 7. In the exemplary embodiment, once the detected temperature hits a trigger point, the component 7 will stop. The trigger point may be just above the ambient temperature and the meat (or wood, metal, etc.). In the exemplary embodiment, the temperature sensor of the safety system 1 can be used instead of the luminescent clothing 8. However, embodiments are not limited, and the temperature sensor may be used with the luminescent clothing 8.

The foregoing is illustrative of example embodiments and is not to be construed as limiting thereof. Although a few example embodiments have been described, those skilled in the art will readily appreciate that many modifications are possible in the exemplary embodiments without materially departing from the novel teachings and advantages of the embodiments. Accordingly, all such modifications are intended to be included within the scope of the embodiments as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A safety system for controlling an operation of a machine, operated by an operator wearing an article of luminescent clothing, the system comprising:
a luminescent sensor configured to emit ultraviolet light toward a target area, and configured to detect light emitted by the article of luminescent clothing;
a motor configured to drive a component of the machine; and
a controller configured to control the motor and the luminescent sensor, wherein if the luminescent sensor detects the light emitted by the article of luminescent clothing within the target area, the controller controls the motor to stop driving the component of the machine.

2. The safety system of claim 1, further comprising:
a beam shaper configured to shape the ultraviolet light emitted toward the target area.

3. The safety system of claim 2, wherein the beam shaper is configured to shape the ultraviolet light into a u-shaped configuration.

4. The safety system of claim 2, wherein the beam shaper is configured to shape the ultraviolet light into a rectangular shape.

5. The safety system of claim 4, wherein the beam shaper is configured to shape the ultraviolet light into the rectangular shape such that longer sides of the rectangle extend in a y axis direction.

6. The safety system of claim 5, wherein the longer sides of the rectangle are substantially 5 inches and shorter sides of the rectangle are substantially 0.5 inches.

7. The safety system of claim 4, wherein the beam shaper is configured to shape the ultraviolet light into the rectangular shape such that longer sides of the rectangle extend in a x axis direction.

8. The safety system of claim 7, wherein the longer sides of the rectangle are substantially 5 inches and shorter sides of the rectangle are substantially 0.5 inches.

9. The safety system of claim 1, wherein the shape of the ultraviolet light emitted towards the target area is a circle.

10. The safety system of claim 9, wherein the circle has a diameter of substantially five inches.

11. The safety system of claim 1, wherein the article of luminescent clothing is a glove with an anti-microbial additive.

12. The safety system of claim 1, wherein the glove is approved by the Food and Drug Administration (FDA) for direct contact with food.

13. The safety system of claim 1, further comprising:
an electrical brake connected to the motor, the electrical brake accepts an instruction from the controller,
wherein the controller controls the electric brake connected to the motor to stop driving the component of the machine when the luminescent sensor detects the light emitted by the article of luminescent clothing within the target area.

14. The safety system of claim 13, wherein the controller stops driving the component of the machine in less than 0.7 seconds.

15. The safety system of claim 1, further comprising:
a dual brake connected to the motor, the dual brake comprises an electric brake and a mechanical brake,
wherein the dual brake accepts an instruction from the controller,
wherein the controller controls the dual brake connected to the motor to stop driving the component of the machine when the luminescent sensor detects the light emitted by the article of luminescent clothing within the target area.

16. The safety system of claim 14, wherein the controller stops driving the component of the machine in less than 0.5 seconds.

17. The safety system of claim 1, wherein the component of the machine is a cutting blade.

18. The safety system of claim 1, wherein a vertical distance from the luminescent sensor to the target area is substantially up to 15.75 inches.

19. A safety system for controlling an operation of a machine operated by an operator wearing an article of luminescent clothing, the system comprising:
a luminescent sensor configured to emit ultraviolet light toward a target area, and configured to detect light emitted by the article of luminescent clothing;
a motor configured to drive a component of the machine;
a dual brake connected to the motor, the dual brake comprises an electric brake and a mechanical brake and accepts an instruction from the controller; and
a controller configured to control the motor and the luminescent sensor, wherein if the luminescent sensor detects the light emitted by the article of luminescent clothing within the target area, the controller controls the dual brake connected to the motor to stop driving the component of the machine.

20. A method of a safety system for controlling an operation of a machine operated by an operator wearing an article of luminescent clothing, comprising:
driving a component of the machine with a motor;
detecting when the article of luminescent clothing enters a target area near the component of the machine; and
controlling the motor to stop driving the component of the machine when the detection occurs.
